(19) United States
(12) Patent Application Publication
(10) Pub. No.: US 2026/0063511 A1
(43) Pub. Date: Mar. 5, 2026

(54) CABLE INSPECTION DEVICE

(71) Applicants: CHINA THREE GORGES RENEWABLES (GROUP) CO., LTD., Beijing (CN); THREE GORGES JINJI (TIANJIN) RENEWABLE ELECTRIC POWER CO., LTD., Tianjin (CN)

(72) Inventors: Shibin WU, Beijing (CN); Hexiang HAN, Beijing (CN); Yang YANG, Beijing (CN); Jianxiang BAI, Beijing (CN)

(73) Assignees: CHINA THREE GORGES RENEWABLES (GROUP) CO., LTD., Beijing (CN); THREE GORGES JINJI (TIANJIN) RENEWABLE ELECTRIC POWER CO., LTD., Tianjin (CN)

(21) Appl. No.: 19/385,587

(22) Filed: Nov. 11, 2025

(30) Foreign Application Priority Data
Jun. 23, 2025 (CN) 202510848571.9

(51) Int. Cl. G01M 13/023

(52) U.S. Cl. CPC G01M 13/023

(57) ABSTRACT

The present invention discloses a cable inspection device, including a main body, a monitoring component, a driving component and a water-wading component. The monitoring component is disposed on the main body, and is adapted to acquire and output a monitoring signal. The driving component is disposed at the bottom of the main body, and is adapted to be movably connected to a cable. The water-wading component is movably connected to the main body, and has a protection state that drives the driving component away from the cable, and a movement state that drives the driving component to contact the cable. The water-wading component can drive the main body away from the water surface, avoiding damage to the components by the accumulated water. The monitoring component can output a monitoring signal at the water accumulation location, so that the staff can timely drain the accumulated water in the cable trench.

### TECHNICAL FIELD

The present disclosure relates to the technical field of cable inspection, and specifically to a cable inspection device.

### BACKGROUND

Power system cables are usually laid in cable trenches. The space inside cable trenches is narrow, the environment is enclosed, and silt accumulates. Furthermore, the cable trenches have long longitudinal distances and narrow cross-sections, while also serving drainage functions. To ensure the safe operation of equipment, periodic inspection of cable trenches is necessary. Because cables within the cable trenches are widely distributed, long in length, exposed to rainwater, in poor environments, and difficult to observe, monitoring every point of the cables is costly and difficult to achieve. If inspection is performed by opening the trench cover plates, this results in high maintenance costs. Therefore, it is difficult to effectively monitor conditions such as temperature of the cables, fire, water accumulation, and animal activity inside the trenches in real time. Once a fault occurs inside a cable trench, handling the fault is usually difficult and time-consuming, seriously threatening and affecting the safe operation of electrical equipment.

In the prior art, automatic inspection apparatuses are usually set up to inspect cables inside cable trenches. When water accumulates in the cable trench, the automatic inspection apparatuses, after wading through water, are prone to malfunction, thereby affecting the cable inspection work.

### SUMMARY OF THE INVENTION

In view of this, the present disclosure provides a cable inspection device to solve the problem in the existing technology where the automatic inspection apparatuses, after wading through water, are prone to malfunction, thereby affecting the cable inspection work.

The present disclosure provides a cable inspection device, including a main body, a monitoring component, a driving component and a water-wading component. The monitoring component is disposed on the main body, and the monitoring component is adapted to acquire and output a monitoring signal. The driving component is disposed at the bottom of the main body, and the driving component is adapted to be movably connected to a cable. The water-wading component is movably connected to the main body, and the water-wading component has a protection state that drives the driving component away from the cable, and a movement state that drives the driving component to contact the cable.

Beneficial effects: in the present disclosure, the water-wading component is disposed on the cable inspection device. When the cable inspection device inspects to a water accumulation environment in the cable trench, the water-wading component can drive the main body provided with the monitoring component and the driving component away from the water surface, avoiding damage to the monitoring component and the driving component by the accumulated water. The monitoring component can output a monitoring signal at the water accumulation location, so that the staff can timely drain the accumulated water in the cable trench.

In an optional implementation, the water-wading component includes a lifting frame and a float component. The lifting frame is movably connected to the main body. The float component is disposed on the main body, and the float component is movably connected to the lifting frame.

Beneficial effects: in the present disclosure, when the cable inspection device moves to an environment with accumulated water in the cable trench, the float component drives the main body to rise along the lifting frame under the buoyancy force of the accumulated water, leaving the water surface, thereby avoiding damage to the monitoring component and the driving component caused by contact between the main body and the accumulated water. After the accumulated water is drained, the float component drives the main body to descend along the lifting frame under its own gravity, and continues to inspect along the cable.

In an optional implementation, the float component includes a first support frame, a sliding member, a first elastic member, a first pull rope, a float and a second pull rope. The first support frame is disposed on the main body, and a first mounting hole is provided on the first support frame. The sliding member is movably installed in the first mounting hole, and the sliding member is movably connected to the driving component. The first elastic member is disposed between the sliding member and the first support frame. The first pull rope is connected to the sliding member. The float is connected to an end of the first pull rope away from the sliding member, and the gravity of the float is greater than the elastic force of the first elastic member. One end of the second pull rope is connected to the sliding member, and the other end is connected to the lifting frame.

Beneficial effects: in the present disclosure, the gravity of the float is set to be greater than the elastic force of the first elastic member. During normal operation, the first elastic member is stretched under the gravity of the float, and the sliding member is separated from the driving component. When the cable inspection device operates to a water accumulation environment, the float floats up under the buoyancy force of the accumulated water, and the first elastic member returns to its original state, causing the sliding member to connect with the driving component. The first pull rope is wound around the sliding member, thereby causing the main body to rise along the lifting frame, thus avoiding damage to the monitoring component and the driving component caused by contact between the main body and the accumulated water.

In an optional implementation, the float component further includes a first connecting member and a second connecting member. The first connecting member is connected to the sliding member. The second connecting member is connected to the driving component, in which one of the first connecting member and the second connecting member is provided with a connection portion, and the other one is provided with a connection groove, and the connection portion is movably connected to the connection groove.

Beneficial effects: in the present disclosure, the first connecting member and the second connecting member are movably connected via the connection portion and the connection groove. When the cable inspection device operates to a water-wading environment with accumulated water, the first connecting member and the second connecting member are connected to each other, and the main body is lifted along the lifting frame via the first pull rope to leave the water surface, thereby avoiding damage to the monitoring component and the driving component caused by contact between the main body and the accumulated water.

In an optional implementation, the float component further includes a first sensor. The first sensor is disposed on the sliding member, and the first sensor is in signal connection with the monitoring component.

Beneficial effects: in the present disclosure, when the first sensor detects accumulated water, it transmits a signal to the monitoring component, which then sends it to the staff, facilitating the staff to timely drain the accumulated water in the cable trench, allowing the cable inspection device to continue inspection, while also avoiding the impact of accumulated water on the cables in the cable trench.

In an optional implementation, the driving component includes a driver, a first transmission shaft, a first transmission belt and driving members. The driver is disposed on the main body. The first transmission shaft is rotatably installed on the main body, and the first transmission shaft is movably connected to the water-wading component and the monitoring component. The first transmission belt connects the driver. Two said driving members are disposed at the bottom of the main body and on both sides of the cable, and the driving members are movably connected to the first transmission shaft.

Beneficial effects: in the present disclosure, two driving members are disposed on both sides of the cable. The driving members drive the first transmission shaft to rotate, causing the driving members to move along the outer wall of the cable, thereby enabling the cable inspection device to inspect along the cable.

In an optional implementation, the driving component further includes a guard plate. The guard plate is disposed at the bottom of the main body, the guard plate is provided with a mounting portion, which matches the shape of the cable, and the mounting portion is movably disposed on the cable.

Beneficial effects: in the present disclosure, the guard plate is disposed above the cable. The guard plate matches the shape of the cable. When the cable inspection device moves along the outer wall of the cable, it can serve a guiding and protective role.

In an optional implementation, the driving component further includes a second sensor, in which the second sensor is disposed on the driver and is adapted to detect a travel distance.

Beneficial effects: in the present disclosure, the second sensor is set to output the travel distance and position of the cable inspection device. If the monitoring component detects an abnormal situation, the position information can be sent to the monitoring center, so that the staff can accurately obtain the location of the abnormality.

In an optional implementation, the monitoring component includes a first monitor and a second monitor. The first monitor is rotatably disposed on the main body, and the first monitor is movably connected to the driving component. The second monitor is fixedly disposed on the main body, and the second monitor is in signal connection with the first monitor and the driving component.

Beneficial effects: the first monitor set in the present disclosure can detect the inspection environment and transmit the detection data to the second monitor for recording and storage. The second monitor can also send the information to the monitoring center, so that the staff can timely obtain the inspection information.

In an optional implementation, the monitoring component further includes a second transmission belt and a second transmission shaft. The second transmission belt is movably connected to the driving component and the water-wading component, respectively. The second transmission shaft is rotatably disposed on the main body, one end of the second transmission shaft is connected to the second transmission belt, and the other end is connected to the first monitor.

Beneficial effects: in the present disclosure, when the driving component drives the cable inspection device to inspect along the cable, the second transmission belt and the second transmission shaft drive the first monitor to rotate, so as to monitor and inspect various angles inside the cable trench, improving the inspection effect.

### BRIEF DESCRIPTION OF THE DRAWINGS

In order to explain the specific implementations of the present disclosure or the technical solutions in the existing technology more clearly, the following will briefly introduce the drawings required for describing the specific implementations or the existing technology. Obviously, the drawings in the following description are some implementations of the present disclosure. For those skilled in the art, other drawings can be obtained based on these drawings without making creative effort.

FIG. 1 is a perspective view of a cable inspection device according to an embodiment of the present disclosure;

FIG. 2 is a perspective view of the cable inspection device with the housing removed according to an embodiment of the present disclosure;

FIG. 3 is a top view of the cable inspection device according to an embodiment of the present disclosure;

FIG. 4 is a right-side view of the cable inspection device according to an embodiment of the present disclosure;

FIG. 5 is a left-side view of the cable inspection device according to an embodiment of the present disclosure;

FIG. 6 is a front view of the cable inspection device according to an embodiment of the present disclosure;

FIG. 7 is a rear view of the cable inspection device according to an embodiment of the present disclosure;

FIG. 8 is a perspective view of the cable inspection device with the housing and the lifting frame removed according to an embodiment of the present disclosure;

FIG. 9 is another perspective view of the cable inspection device with the housing and the lifting frame removed according to an embodiment of the present disclosure;

FIG. 10 is a perspective view of a first connecting member in the cable inspection device according to an embodiment of the present disclosure;

FIG. 11 is a perspective view of a second connecting member in the cable inspection device according to an embodiment of the present disclosure;

FIG. 12 is a side view of the cable inspection device in the movement state according to an embodiment of the present disclosure;

FIG. 13 is a side view of the cable inspection device in the protection state according to an embodiment of the present disclosure.

### DESCRIPTION OF REFERENCE NUMERALS:

1. main body; 11. base plate; 12. housing; 13. second support frame; 14. sensing patch; 15. third support frame;

2. monitoring component; 21. first monitor; 211. worm wheel; 22. second monitor; 23. second transmission belt; 24. second transmission shaft; 241. worm gear; 242. fourth gear;

3. driving component; 31. driver; 311. drive gear; 32. first transmission shaft; 321. first gear; 322. second gear; 323. bevel gear; 33. first transmission belt; 34. driving member; 341. third gear; 342. connecting rod; 343. drive wheel; 35. guard plate; 36. second sensor; 37. auxiliary wheel;

4. water-wading component; 41. lifting frame; 411. column; 412. beam; 413. base wheel; 42. float component; 421. first support frame; 422. sliding member; 423. first elastic member; 424. first pull rope; 425. float; 426. second pull rope; 427. first connecting member; 428. second connecting member; 4281. friction wheel; 43. sleeve; 44. second elastic member; 45. first sensor; 451. water accumulation patch; 452. water accumulation sensing piece;

5. cable.

### DETAILED DESCRIPTION OF IMPLEMENTATION

In order to make the purpose, technical solutions and advantages of the embodiments of the present disclosure more clear, the technical solutions in the embodiments of the present disclosure will be described clearly and completely with reference to the accompanying drawings. Obviously, the described embodiments are only a part of the embodiments of the present disclosure, but not all of them. Based on the embodiments of the present disclosure, all other embodiments obtained by those of ordinary skill in the art without creative effort shall fall within the protection scope of the present disclosure.

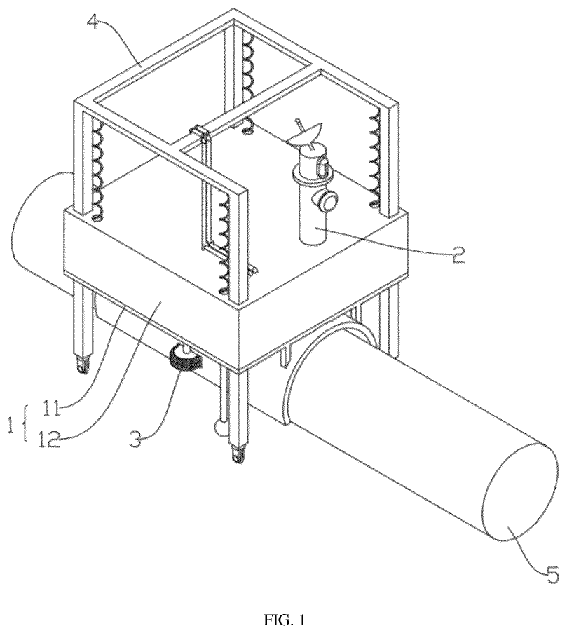

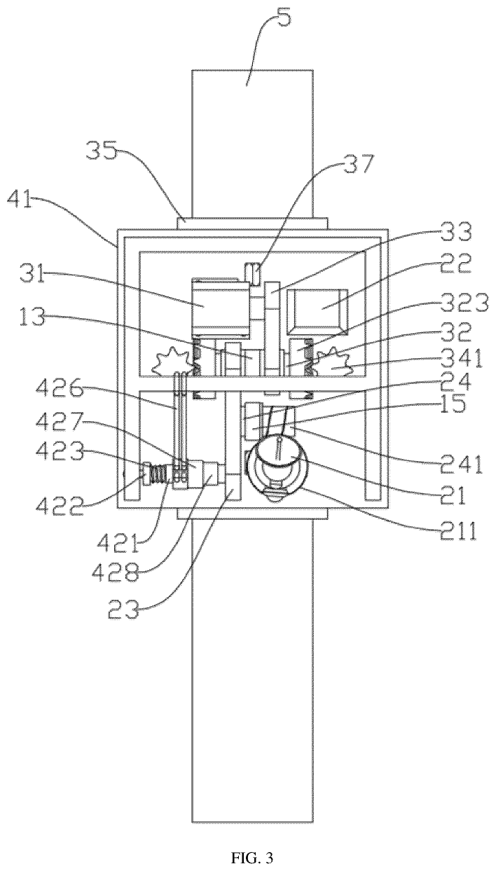

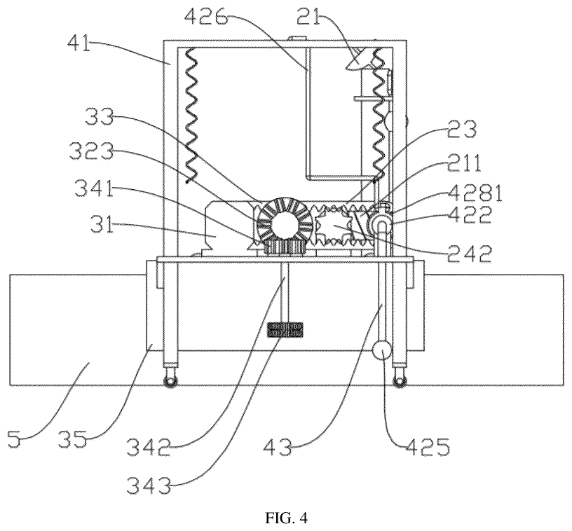

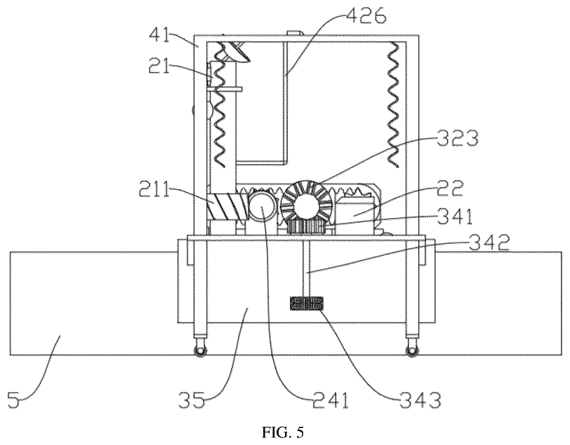

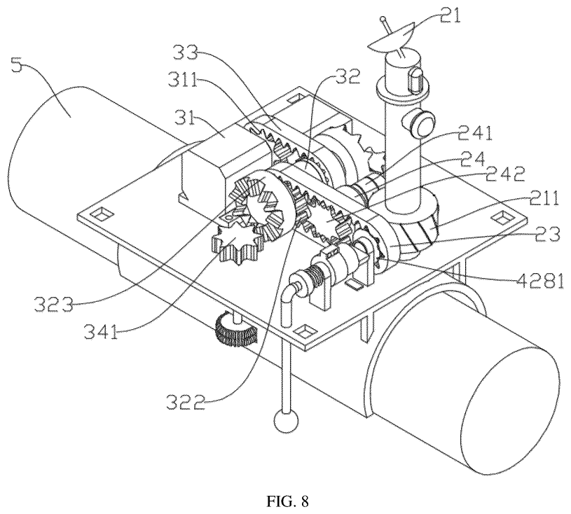

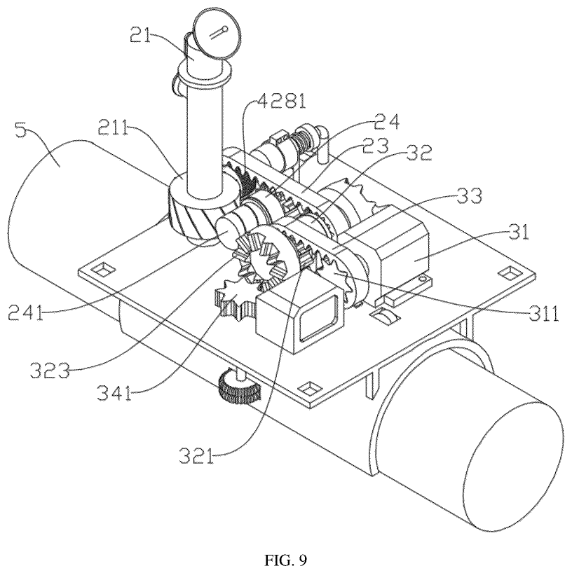

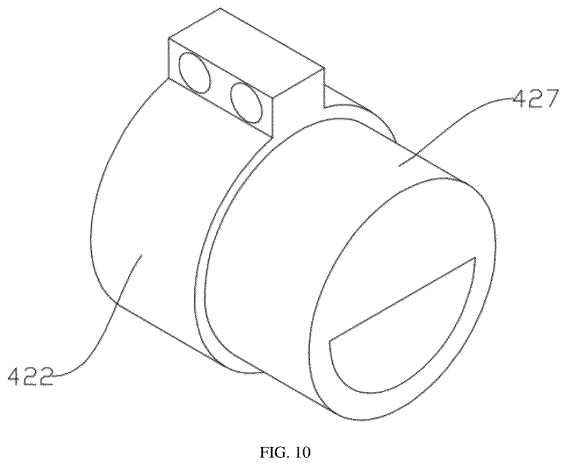

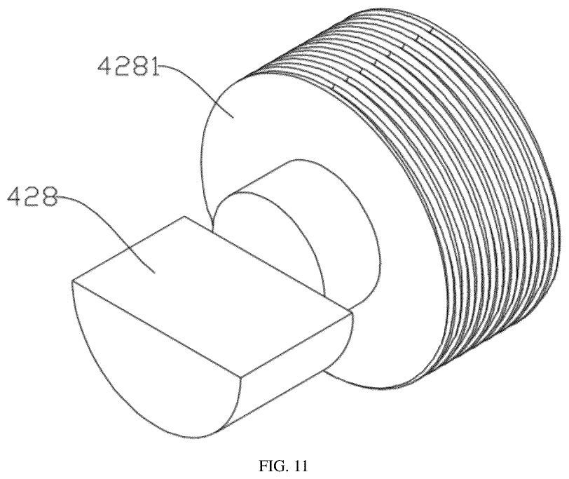

The following describes the embodiments of the present disclosure with reference to FIGS. 1 to 13.

According to an embodiment of the present disclosure, as shown in FIGS. 1 to 13, a cable inspection device is provided, comprising a main body 1, a monitoring component 2, a driving component 3 and a water-wading component 4. The monitoring component 2 is disposed on the main body 1, and the monitoring component 2 is adapted to acquire and output a monitoring signal. The driving component 3 is disposed at the bottom of the main body 1, and the driving component 3 is adapted to be movably connected to a cable 5. The water-wading component 4 is movably connected to the main body 1, and the water-wading component 4 has a protection state that drives the driving component 3 away from the cable 5, and a movement state that drives the driving component 3 to contact the cable 5.

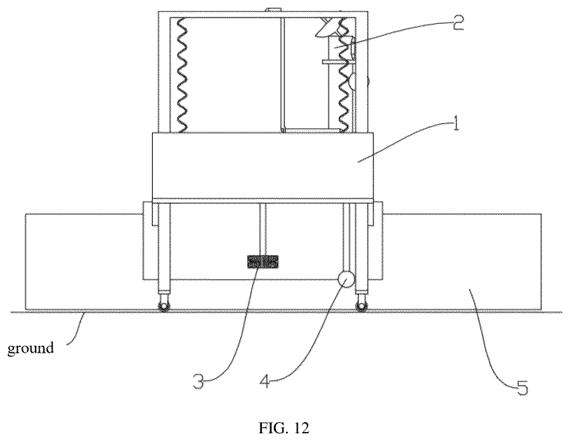

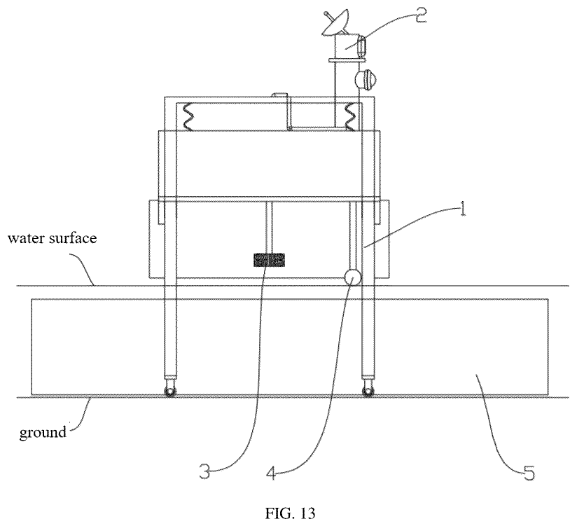

Specifically, as shown in FIG. 1, the main body 1 in this embodiment is not specifically limited. For example, in this embodiment, the main body 1 has a cubic structure. The main body 1 includes a base plate 11 and a housing 12. The housing 12 is installed on the base plate 11. The monitoring component 2 is installed on the base plate 11. The top of the monitoring component 2 passes through the housing 12 and extends outside the housing 12. The monitoring component 2 is used to acquire and output a monitoring signal. The driving component 3 is installed on the base plate 11. The bottom of the driving component 3 passes through the base plate 11 and is movably connected to the cable 5, for driving the main body 1 to move along the length direction of the cable 5. The water-wading component 4 is movably installed on the base plate 11. As shown in FIG. 13, when the cable inspection device moves to an area with accumulated water in the cable trench, the water-wading component 4 drives the main body 1 to rise, causing the driving component 3 to separate from the cable 5, which is in the protection state, avoiding damage to the monitoring component 2 and the driving component 3 in the main body 1 by the accumulated water. As shown in FIG. 12, after the accumulated water is drained, the water-wading component 4 drives the main body 1 to descend, causing the driving component 3 to contact the cable 5, which is in the movement state, and the cable inspection device can inspect along the cable 5.

In the present disclosure, the water-wading component 4 is disposed on the cable inspection device. When the cable inspection device inspects to a water accumulation environment in the cable trench, the water-wading component 4 can drive the main body 1 provided with the monitoring component 2 and the driving component 3 away from the water surface, avoiding damage to the monitoring component 2 and the driving component 3 by the accumulated water. The monitoring component 2 can output a monitoring signal at the water accumulation location, so that the staff can timely drain the accumulated water in the cable trench.

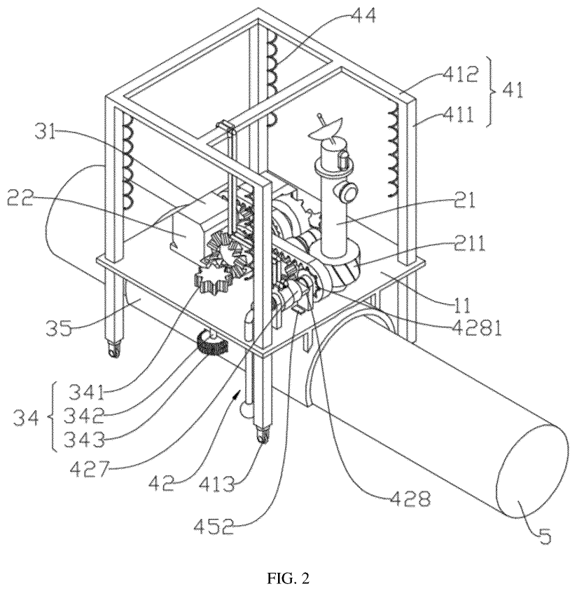

In one embodiment, as shown in FIGS. 1 and 2, the water-wading component 4 includes a lifting frame 41 and a float component 42. The lifting frame 41 is movably connected to the main body 1. The float component 42 is disposed on the main body 1, and the float component 42 is movably connected to the lifting frame 41.

Specifically, as shown in FIGS. 1 and 2, in this embodiment, the lifting frame 41 includes columns 411 and beams 412. A number of columns 411 are vertically disposed. Some beams 412 are horizontally connected to the tops of the columns 411. For example, in this embodiment, the lifting frame 41 is provided with four columns 411 and four beams 412. The four columns 411 are symmetrically vertically disposed. Three of the beams 412 are respectively connected to the tops of two columns 411. The other beam 412 is connected to two oppositely disposed beams 412, so that the lifting frame 41 forms a frame structure. The bottom of the columns 411 is provided with base wheels 413.

In this embodiment, the height of the lifting frame 41 is less than the height inside the cable trench, and when the main body 1 rises along the lifting frame 41 to the highest position, the top of the first monitor 21 is located below the top of the cable trench. This can both ensure the normal movement of the cable inspection device in the water-free section of the cable trench, and avoid collision between the cable inspection device and the top of the cable trench in the water accumulation section.

In this embodiment, as shown in FIG. 1, the four corners of the main body 1 are correspondingly provided with four openings. The columns 411 pass through the openings and are movably connected to the main body 1. The float component 42 is disposed on the base plate 11. When the cable 5 inspection component moves to a water accumulation environment, the float component 42 drives the main body 1 to rise along the columns 411 under the buoyancy force of the accumulated water, causing the driving component 3 to separate from the cable 5 at the water accumulation location, avoiding contact between the monitoring component 2 and the driving component 3 on the base plate 11 and the accumulated water. After the accumulated water is drained, the float component 42 drives the main body 1 to descend along the columns 411 under gravity, causing the driving component 3 to contact the cable 5, and under the action of the driving component 3, it inspects along the cable 5.

In the present disclosure, when the cable inspection device moves to an environment with accumulated water in the cable trench, the float component 42 drives the main body 1 to rise along the lifting frame 41 under the buoyancy force of the accumulated water, leaving the water surface, thereby avoiding damage to the monitoring component 2 and the driving component 3 caused by contact between the main body 1 and the accumulated water. After the accumulated water is drained, the float component 42 drives the main body 1 to descend along the lifting frame 41 under its own gravity, and continues to inspect along the cable 5.

In one embodiment, as shown in FIGS. 2 to 7, the float component 42 includes a first support frame 421, a sliding member 422, a first elastic member 423, a first pull rope 424, a float 425 and a second pull rope 426. The first support frame 421 is disposed on the main body 1, and a first mounting hole is provided on the first support frame 421. The sliding member 422 is movably installed in the first mounting hole, and the sliding member 422 is movably connected to the driving component 3. The first elastic member 423 is disposed between the sliding member 422 and the first support frame 421. The first pull rope 424 is connected to the sliding member 422. The float 425 is connected to an end of the first pull rope 424 away from the sliding member 422, and the gravity of the float 425 is greater than the elastic force of the first elastic member 423. One end of the second pull rope 426 is connected to the sliding member 422, and the other end is connected to the lifting frame 41.

Specifically, in this embodiment, the first support frame 421 is disposed on the base plate 11. The first support frame 421 is provided with a circular first mounting hole. The cylindrical sliding member 422 is movably passed through the first mounting hole. The base plate 11 is provided with a sleeve 43. The upper end of the sleeve 43 faces the sliding member 422. The bottom end of the sleeve 43 extends out of the base plate 11 downward. One end of the sliding member 422 is provided with the first pull rope 424. The other end of the first pull rope 424 passes through the sleeve 43 and extends to the bottom of the base plate 11. The float 425 is connected to the end of the first pull rope 424 away from the sliding member 422. Both ends of the sliding member 422 are provided with limiting portions. The first elastic member 423 is disposed between the limiting portion on the side near the sleeve 43 and the first support frame 421. The gravity of the float 425 is greater than the elastic force of the first elastic member 423. The end of the sliding member 422 away from the sleeve 43 is movably connected to the driving component 3. One end of the second pull rope 426 is connected to the sliding member 422, and the other end is connected to the beam 412. A second elastic member 44 is disposed between the top of the housing 12 and the beam 412.

In this embodiment, the first elastic member 423 is not specifically limited. For example, in this embodiment, the first elastic member 423 is a spring. The spring is sleeved on the sliding member 422. During normal operation of the cable inspection device, under the weight of the float 425, the sliding member 422 is pulled via the first pull rope 424 to separate from the driving component 3. The spring is stretched at this time. When the cable inspection device operates to a water accumulation location, the float 425 floats up under the buoyancy force of the accumulated water. The spring drives the sliding member 422 to move toward the driving component 3 via elastic force, and connects with the driving component 3. The sliding member 422 rotates with the driving component 3, winding the second pull rope 426 on the outer wall of the sliding member 422. As the second pull rope 426 is wound on the sliding member 422, the sliding member 422 rises, driving the main body 1 to move upward, causing the bottom of the main body 1 to move away from the accumulated water.

In this embodiment, the second elastic member 44 is not specifically limited. For example, in this embodiment, the second elastic member 44 is a spring. When the cable inspection device is moving and inspecting, the main body 1 is at a lower position on the lifting frame 41, and the second elastic member 44 is stretched. When the cable inspection device moves to a water accumulation location, the main body 1 rises along the lifting frame 41 under the pulling force of the second pull rope 426 and the elastic force of the second elastic member 44.

In the present disclosure, the gravity of the float 425 is set to be greater than the elastic force of the first elastic member 423. During normal operation, the first elastic member 423 is stretched under the gravity of the float 425, and the sliding member 422 is separated from the driving component 3. When the cable inspection device operates to a water accumulation environment, the float 425 floats up under the buoyancy force of the accumulated water, and the first elastic member 423 returns to its original state, causing the sliding member 422 to connect with the driving component 3. The first pull rope 424 is wound around the sliding member 422, thereby causing the main body 1 to rise along the lifting frame 41, thus avoiding damage to the monitoring component 2 and the driving component 3 caused by contact between the main body 1 and the accumulated water.

In one embodiment, as shown in FIGS. 2, 10 and 11, the float component 42 further includes a first connecting member 427 and a second connecting member 428. The first connecting member 427 is connected to the sliding member 422. The second connecting member 428 is connected to the driving component 3, wherein one of the first connecting member 427 and the second connecting member 428 is provided with a connection portion, and the other one is provided with a connection groove, and the connection portion is movably connected to the connection groove.

Specifically, in this embodiment, the first connecting member 427 is connected to the limiting portion at the end of the sliding member 422 away from the sleeve 43. The side of the first connecting member 427 facing the driving component 3 is provided with a semicircular groove. One end of the second connecting member 428 is connected to the driving component 3 and can rotate with the driving component 3. The end of the second connecting member 428 facing the first connecting member is provided with a semicircular disk matching the semicircular groove. During normal operation of the cable inspection device, under the weight of the float 425, the sliding member 422 is pulled toward the sleeve 43 side via the first pull rope 424, causing the first connecting member 427 to separate from the second connecting member. At this time, the drive wheel 343 contacts the outer wall of the cable 5, and the cable inspection device can move along the cable 5. When the cable inspection device operates to a water accumulation location, the float 425 floats up under the buoyancy force. The first elastic member 423 drives the sliding member 422 to move toward the second connecting member 428 via elastic force, and causes the semicircular groove on the first connecting member 427 to connect with the semicircular second connecting member 428. The first connecting member 427 rotates synchronously with the second connecting member 428, winding the second pull rope 426 on the outer wall of the sliding member 422. As the second pull rope 426 is wound on the sliding member 422, the sliding member 422 rises, driving the main body 1 to move upward along the lifting frame 41, causing the bottom of the main body 1 to move away from the accumulated water. At this time, the drive wheel 343 separates from the outer wall of the cable 5, and the cable inspection device stops moving. After the staff drains the accumulated water, the main body 1 descends along the lifting frame 41 to contact the cable 5, and continues to move along the cable for inspection.

In the present disclosure, the first connecting member 427 and the second connecting member 428 are movably connected via the connection portion and the connection groove. When the cable inspection device operates to a water-wading environment with accumulated water, the first connecting member 427 and the second connecting member 428 are connected to each other, and the main body 1 is lifted along the lifting frame 41 via the first pull rope 424 to leave the water surface, thereby avoiding damage to the monitoring component 2 and the driving component 3 caused by contact between the main body 1 and the accumulated water.

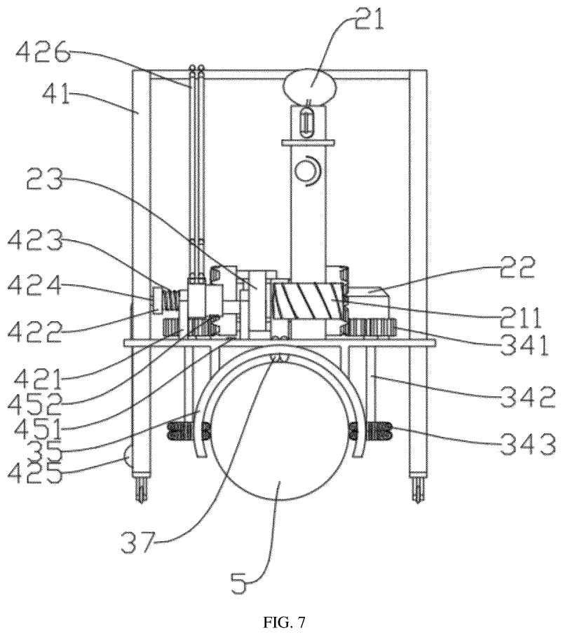

In one embodiment, as shown in FIGS. 2 and 7, the float component 42 further includes a first sensor 45. The first sensor 45 is disposed on the sliding member 422, and the first sensor 45 is in signal connection with the monitoring component 2.

Specifically, in this embodiment, the first sensor 45 includes a water accumulation patch 451 and a water accumulation sensing piece 452. The water accumulation sensing piece 452 is in signal connection with the monitoring component 2. The water accumulation patch 451 is installed on the sliding member 422. The water accumulation sensing piece 452 is installed above the base plate 11. When the first connecting member 427 and the second connecting member 428 are connected, the water accumulation patch 451 and the water accumulation sensing piece 452 sense each other. The water accumulation patch 451 sends a signal to the monitoring component 2 for recording the water accumulation location. When the first connecting member 427 and the second connecting member 428 separate, the water accumulation patch 451 and the water accumulation sensing piece 452 will also sense each other, and simultaneously send a separation signal to the monitoring component 2 to record the departure from the water accumulation location.

In the present disclosure, when the first sensor 45 detects accumulated water, it transmits a signal to the monitoring component 2, which then sends it to the staff, facilitating the staff to timely drain the accumulated water in the cable trench, allowing the cable inspection device to continue inspection, while also avoiding the impact of accumulated water on the cables 5 in the cable trench.

In one embodiment, as shown in FIGS. 2 to 9, the driving component 3 includes a driver 31, a first transmission shaft 32, a first transmission belt 33 and driving members 34. The driver 31 is disposed on the main body 1. The first transmission shaft 32 is rotatably installed on the main body 1, and the first transmission shaft 32 is movably connected to the water-wading component 4 and the monitoring component 2. The first transmission belt 33 connects the driver 31 and the first transmission shaft 32. Two said driving members 34 are disposed at the bottom of the main body 1 and on both sides of the cable 5, and the driving members 34 are movably connected to the first transmission shaft 32.

Specifically, in this embodiment, the driver 31 is not specifically limited. For example, in this embodiment, the driver 31 is a motor. The driver 31 is installed above the base plate 11. The output shaft of the driver 31 is provided with a drive gear 311. The base plate 11 is provided with a second support frame 13. The second support frame 13 is provided with a second mounting hole. The first transmission shaft 32 is horizontally rotatably installed in the second mounting hole. The first transmission shaft 32 is provided with a first gear 321 and a second gear 322. The first transmission belt 33 is installed on the drive gear 311 and the first gear 321. The end of the second connecting member 428 away from the connection portion is provided with a friction wheel 4281. A second transmission belt 23 is installed on the second gear 322 and the friction wheel 4281. The second transmission belt 23 is movably connected to the monitoring component 2. Both ends of the first transmission shaft 32 are respectively provided with a bevel gear 323. The driving member 34 includes a third gear 341, a connecting rod 342 and a drive wheel 343. Two connecting rods 342 pass through the base plate 11. The upper end of the connecting rod 342 is connected to the third gear 341. The lower end of the connecting rod 342 is connected to the drive wheel 343. The third gear 341 meshes with the bevel gear 323. The drive wheel 343 abuts against the cable 5. The two drive wheels 343 are located on both sides of the cable 5, respectively. The bottom of the main body 1 is provided with an auxiliary wheel 37. The auxiliary wheel 37 abuts against the top of the cable 5. The base plate 11 is provided with a slot. The auxiliary wheel 37 can rotate in the slot, avoiding friction between the auxiliary wheel 37 and the base plate 11.

In this embodiment, the first transmission belt 33 and the second transmission belt 23 are not specifically limited. For example, in this embodiment, the first transmission belt 33 and the second transmission belt 23 are synchronous toothed belts, and the inner wall of the synchronous toothed belt is provided with teeth.

In the present disclosure, two driving members 34 are disposed on both sides of the cable 5. The driving members 34 drive the first transmission shaft 32 to rotate, causing the driving members 34 to move along the outer wall of the cable 5, thereby enabling the cable inspection device to inspect along the cable 5.

In one embodiment, as shown in FIGS. 2 to 7, the driving component 3 further includes a guard plate 35. The guard plate 35 is disposed at the bottom of the main body 1, the guard plate 35 is provided with a mounting portion, which matches the shape of the cable 5, and the mounting portion is movably disposed on the cable 5.

Specifically, in this embodiment, the bottom of the base plate 11 is installed with the guard plate 35. The guard plate 35 is arc-shaped. The side of the guard plate 35 facing the cable 5 is provided with an arc-shaped mounting portion matching the shape of the cable 5. The side and top of the guard plate 35 are provided with slots. The drive wheel 343 and the auxiliary wheel 37 can rotate in the slots.

In the present disclosure, the guard plate 35 is disposed above the cable 5. The guard plate 35 matches the shape of the cable 5. When the cable inspection device moves along the outer wall of the cable 5, it can serve a guiding and protective role.

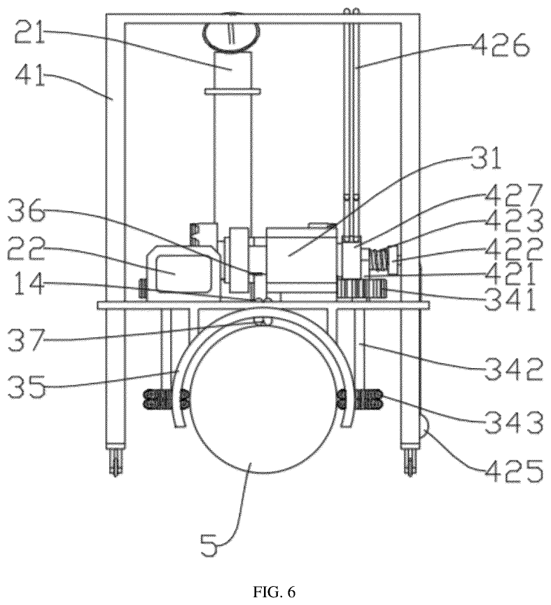

In one embodiment, as shown in FIG. 6, the driving component 3 further includes a second sensor 36, wherein the second sensor 36 is disposed on the driver 31 and is adapted to detect a travel distance.

Specifically, in this embodiment, the drive shaft of the driver 31 is provided with the second sensor 36. The base plate 11 is correspondingly installed with a sensing patch 14. The second sensor 36 is in signal connection with the monitoring component 2. The driver 31 rotates to drive the drive gear 311 to rotate, thereby driving the first transmission belt 33 to rotate, which in turn drives the first gear 321 to rotate. As the first transmission shaft 32 rotates, it drives the bevel gears 323 on both sides to rotate. The third gear 341 rotates with the bevel gear 323, driving the drive wheel 343 to rotate on the surface of the cable 5. Cooperating with the auxiliary wheel 37, the main body 1 moves along the cable 5. The rotation of the driver 31 will drive the second sensor 36 to rotate with the output shaft. Cooperating with the sensing patch 14 to sense the second sensor 36, the travel distance is recorded, and the distance signal is sent to the monitoring component 2.

In the present disclosure, the second sensor 36 is set to output the travel distance and position of the cable inspection device. If the monitoring component 2 detects an abnormal situation, the position information can be sent to the monitoring center, so that the staff can accurately obtain the location of the abnormality.

In one embodiment, as shown in FIGS. 2 to 9, the monitoring component 2 includes a first monitor 21 and a second monitor 22. The first monitor 21 is rotatably disposed on the main body 1, and the first monitor 21 is movably connected to the driving component 3. The second monitor 22 is fixedly disposed on the main body 1, and the second monitor 22 is in signal connection with the first monitor 21 and the driving component 3.

Specifically, in this embodiment, the first monitor 21 and the second monitor 22 are not specifically limited. For example, in this embodiment, the first monitor 21 is a thermal imager, and the second monitor 22 is a recorder.

In this embodiment, the first monitor 21 is rotatably installed on the base plate 11. The lower position of the first monitor 21 is provided with a worm wheel 211. The base plate 11 is provided with a third support frame 15. The third support frame 15 is provided with a third mounting hole. A second transmission shaft 24 is rotatably installed in the third mounting hole. One end of the second transmission shaft 24 is provided with a worm gear 241 that cooperates with the worm wheel 211. The other end is provided with a fourth gear 242. The fourth gear 242 is connected to the second transmission belt 23. And the first transmission shaft 32 and the second transmission shaft 24 are parallel to each other.

In this embodiment, when the second gear 322 rotates, it drives the fourth gear 242 to rotate via the second transmission belt 23, thereby driving the worm gear 241 to rotate. The worm wheel 211 rotates with the worm gear 241, thereby driving the first monitor 21 to rotate. When the first monitor 21 continuously rotates, the camera on the first monitor 21 rotates accordingly. When the first monitor 21 detects an abnormality, the recorder controls the driver 31 to stop, and the camera on the first monitor 21 takes photos, recording and identifying the detected situation. The second sensor 36 on the driver 31 will cooperate with the sensing patch 14 to continuously record the travel distance of the device. When the first monitor 21 detects an abnormal situation, the recorder synchronously records the current position of the device, and the radar on the first monitor 21 sends the information to the monitoring center.

The first monitor 21 set in the present disclosure can detect the inspection environment and transmit the detection data to the second monitor 22 for recording and storage. The second monitor 22 can also send the information to the monitoring center, so that the staff can timely obtain the inspection information.

In one embodiment, as shown in FIGS. 2 to 9, the monitoring component 2 further includes a second transmission belt 23 and a second transmission shaft 24. The second transmission belt 23 is movably connected to the driving component 3 and the water-wading component 4, respectively. The second transmission shaft 24 is rotatably disposed on the main body 1, one end of the second transmission shaft 24 is connected to the second transmission belt 23, and the other end is connected to the first monitor 21.

In the present disclosure, when the driving component 3 drives the cable inspection device to inspect along the cable 5, the second transmission belt 23 and the second transmission shaft 24 drive the first monitor 21 to rotate, so as to monitor and inspect various angles inside the cable trench, improving the inspection effect.

The working process of the cable inspection device in the present disclosure is as follows:

During inspection work, the main body 1 is installed on the cable 5 in the cable trench, so that the two drive wheels 343 and the auxiliary wheel 37 clamp on the cable 5, and the four base wheels 413 support on the ground of the cable trench. The driving component 3 and the monitoring component 2 are started. The driver 31 drives the drive gear 311 to rotate, driving the first transmission belt 33 to move. The first transmission belt 33 drives the bevel gear 323 to rotate. The bevel gear 323 drives the third gear 341 to rotate, thereby driving the drive wheel 343 to move along both sides of the cable 5, causing the cable inspection device to move and inspect along the cable 5. At the same time, the second gear 322 drives the second transmission belt 23 to rotate, causing the fourth gear 242 to drive the worm gear 241 to rotate. The worm gear 241 drives the worm wheel 211 to rotate, causing the first monitor 21 to rotate, achieving monitoring in different directions.

When the cable inspection device moves normally, the float 425 pulls the first connecting member 427 to separate from the second connecting member 428 under gravity. The second transmission belt 23 drives the friction wheel 4281 to idle. During the inspection process, when the cable inspection device moves to a water accumulation location, the float 425 floats up under the buoyancy force of the accumulated water, causing the first connecting member 427 and the second connecting member 428 to engage with each other. As the first connecting member 427 rotates, the second pull rope 426 is wound on the first connecting member, thereby lifting the main body 1 upward along the lifting frame 41, avoiding contact between the main body 1 and the accumulated water. At the same time, the drive wheel 343 separates from the cable 5, and the cable inspection device stops moving and inspecting, sending out information about the water accumulation location. After the staff drains the accumulated water, the float 425 descends again under gravity, pulling the first connecting member 427 to separate from the second connecting member 428. Then, the drive wheel 343 contacts the cable 5, and inspection can continue.

The cable inspection device in the present disclosure can not only inspect the cable 5 and the environment in the cable trench, but also detect whether there is accumulated water in the cable trench, timely sending a water accumulation signal to facilitate maintenance of the cable trench by the staff, avoiding the impact of accumulated water in the cable trench on the cable 5.

Although the embodiments of the present disclosure have been described in combination with the drawings, those skilled in the art can make various modifications and variations without departing from the spirit and scope of the present disclosure. Such modifications and variations shall fall within the scope defined by the appended claims.

1. A cable inspection device, comprising:
a main body;
a monitoring component, wherein the monitoring component is disposed on the main body, and the monitoring component is adapted to acquire and output a monitoring signal;
a driving component, wherein the driving component is disposed at the bottom of the main body, and the driving component is adapted to be movably connected to a cable; and
a water-wading component, wherein the water-wading component is movably connected to the main body, and the water-wading component has a protection state that drives the driving component away from the cable, and a movement state that drives the driving component to contact the cable.

2. The cable inspection device according to claim 1, wherein the water-wading component comprises:
a lifting frame, wherein the lifting frame is movably connected to the main body; and
a float component, wherein the float component is disposed on the main body, and the float component is movably connected to the lifting frame.

3. The cable inspection device according to claim 2, wherein the float component comprises:
a first support frame, wherein the first support frame is disposed on the main body, and a first mounting hole is provided on the first support frame;
a sliding member, wherein the sliding member is movably installed in the first mounting hole, and the sliding member is movably connected to the driving component;
a first elastic member, wherein the first elastic member is disposed between the sliding member and the first support frame;
a first pull rope, wherein the first pull rope is connected to the sliding member;
a float, wherein the float is connected to an end of the first pull rope away from the sliding member, and the gravity of the float is greater than the elastic force of the first elastic member; and
a second pull rope, wherein one end of the second pull rope is connected to the sliding member, and the other end is connected to the lifting frame.

4. The cable inspection device according to claim 3, wherein the float component further comprises:
a first connecting member, wherein the first connecting member is connected to the sliding member; and
a second connecting member, wherein the second connecting member is connected to the driving component, wherein one of the first connecting member and the second connecting member is provided with a connection portion, and the other one is provided with a connection groove, and the connection portion is movably connected to the connection groove.

5. The cable inspection device according to claim 3, wherein the float component further comprises:
a first sensor, wherein the first sensor is disposed on the sliding member, and the first sensor is in signal connection with the monitoring component.

6. The cable inspection device according to claim 1, wherein the driving component comprises:
a driver, wherein the driver is disposed on the main body;
a first transmission shaft, wherein the first transmission shaft is rotatably installed on the main body, and the first transmission shaft is movably connected to the water-wading component and the monitoring component;
a first transmission belt, wherein the first transmission belt connects the driver and the first transmission shaft; and
driving members, wherein two said driving members are disposed at the bottom of the main body and on both sides of the cable, and the driving members are movably connected to the first transmission shaft.

7. The cable inspection device according to claim 6, wherein the driving component further comprises:
a guard plate, wherein the guard plate is disposed at the bottom of the main body, the guard plate is provided with a mounting portion, which matches the shape of the cable, and the mounting portion is movably disposed on the cable.

8. The cable inspection device according to claim 6, wherein the driving component further comprises:
a second sensor, wherein the second sensor is disposed on the driver and is adapted to detect a travel distance.

9. The cable inspection device according to claim 1, wherein the monitoring component comprises:
a first monitor, wherein the first monitor is rotatably disposed on the main body, and the first monitor is movably connected to the driving component; and
a second monitor, wherein the second monitor is fixedly disposed on the main body, and the second monitor is in signal connection with the first monitor and the driving component.

10. The cable inspection device according to claim 9, wherein the monitoring component further comprises:
a second transmission belt, wherein the second transmission belt is movably connected to the driving component and the water-wading component, respectively; and
a second transmission shaft, wherein the second transmission shaft is rotatably disposed on the main body, one end of the second transmission shaft is connected to the second transmission belt, and the other end is connected to the first monitor.
